(19) United States
(12) Patent Application Publication
(10) Pub. No.: US 2009/0029112 A1
(43) Pub. Date: Jan. 29, 2009

(54) OPTICAL ELEMENT, METHOD OF MANUFACTURING THE SAME, LIQUID CRYSTAL DISPLAY DEVICE, AND ELECTRONIC APPARATUS

(75) Inventor: Toshihiro OTAKE, Suwa-shi (JP)

Correspondence Address: LOWE HAUPTMAN HAM & BERNER, LLP, 1700 DIAGONAL ROAD, SUITE 300, ALEXANDRIA, VA, 22314, US

(73) Assignee: SEIKO EPSON CORPORATION, Shinjuku-ku (JP)

(21) Appl. No.: 12/126,068

(22) Filed: May 23, 2008

(30) Foreign Application Priority Data
Jul. 27, 2007 (JP) 2007-195514

(51) Int. Cl. B32B 3/30; B05D 5/06

(52) U.S. Cl. 428/167; 427/162

(57) ABSTRACT

An optical element having a polarizing function includes: a plurality of linear protrusions that are formed of a conductive material and are provided substantially in parallel to each other on a base; and a protective layer that covers upper parts of the plurality of protrusions such that cavity portions are formed between adjacent protrusions. An upper half of each of the protrusions close to the protective layer has a maximum width.

### BACKGROUND

1. Technical Field

The present invention relates to an optical element, a method of manufacturing the same, a liquid crystal display device, and an electronic apparatus.

2. Related Art

As an example of the optical elements having a polarizing function, a wire grid polarizing element has been known. The wire grid polarizing element includes a plurality of minute linear protrusions that are formed of a conductive material and are arranged in parallel to each other at pitches that are smaller than the wavelength of light. The optical element reflects light components that are polarized in a direction parallel to the direction in which the protrusions extend, among incident light components, and transmits light components that are polarized in a direction orthogonal to the direction in which the protrusions extend. The wire grid polarizing element is sensitive to the surrounding environment. Therefore, optical characteristics of the wire grid polarizing element vary according to a change in the reflective index of the surrounding material, or the optical characteristics are likely to deteriorate due to water or sulfur contained in the surrounding atmosphere.

In the wire grid polarizing element, a structure in which a protective layer formed of a different material from that forming the protrusion is formed on the protrusions has been proposed (for example, see Japanese Unexamined Patent Application Publication No. 2007-17762). According to such a structure, the protective layer and the substrate having the wire grid polarizing element provided thereon protect the protrusions from the surrounding environment, and cavity portions formed between the protrusions make it possible to maintain the refractive index of a material around a conductive wire to be constant.

However, in a process of applying a material onto the protrusions to form the protective layer, when the material forming the protective layer is inserted into a space between the protrusions, the cavity portion is filled with the inserted material, which results in the deterioration of the optical characteristics of the wire grid polarizing element. Therefore, it is necessary to prevent the material forming the protective layer from being inserted into the space between the protrusions. However, in this case, some manufacturing conditions, such as the direction in which the protective layer is formed, are restricted.

### SUMMARY

An advantage of some aspects of the invention is to provide an optical element having high optical characteristics and high durability, a method of manufacturing the same, a liquid crystal display device, and an electronic apparatus.

According to an aspect of the invention, an optical element having a polarizing function includes: a plurality of linear protrusions that are formed of a conductive material and are provided substantially in parallel to each other on a base; and a protective layer that covers both upper parts of the plurality of protrusions and cavity portions formed between adjacent protrusions. An upper half of each of the protrusions close to the protective layer has a maximum width.

According to the above-mentioned structure, since the upper half of each of the protrusions close to the protective layer has the maximum width, it is possible to increase the surface area of the upper part of each of the protrusions that come into contact with the protective layer. Therefore, when the protective layer is formed on the protrusions, the surface area of the protective layer supported by the protrusions increases, and it is possible to prevent the material forming the protective layer from being inserted into a space between adjacent protrusions. In this way, it is possible to reliably form the cavity portions between the protrusions, and thus provide an optical element having high optical characteristics and durability.

In the optical element according to the above-mentioned aspect, preferably, the width of a lower half of each of the protrusions close to the base is gradually decreased toward the base.

According to the above-mentioned structure, since the width of the lower half of each of the protrusions close to the base is gradually decreased toward the base, the gap between adjacent protrusions is gradually increased toward the base. In this way, the space between adjacent protrusions on the base side is increased, and thus it is possible to ensure a space for the cavity portion between the protrusions.

In the optical element according to the above-mentioned aspect, preferably, the maximum value of the width of the protrusion is larger than half of the pitch between the plurality of protrusions.

According to the above-mentioned structure, since the maximum value of the width of the protrusion is larger than half of the pitch between the plurality of protrusions, the gap between adjacent protrusions on the protective layer side is smaller than the width of the protrusion. Therefore, the surface area of an upper part of each of the protrusions that come into contact with the protective layer increases, and the gap between adjacent protrusions on the protective layer side decreases. In this way, it is possible to prevent a material forming the protective layer from being inserted into a space between adjacent protrusions.

In the optical element according to the above-mentioned aspect, preferably, the minimum value of the width of the protrusion is smaller than half of the pitch between the plurality of protrusions.

According to the above-mentioned structure, since the minimum value of the width of the protrusion is smaller than half of the pitch between the plurality of protrusions, the gap between adjacent protrusions on the base side is larger than the width of the protrusion. In this way, eve when the gap between adjacent protrusions on the protective layer side is small, it is possible to increase the space between adjacent protrusions on the base side.

In the optical element according to the above-mentioned aspect, preferably, the protective layer is formed of a transparent resin material.

According to the above-mentioned structure, since the transparent resin material is arranged on the protrusions, it is possible to easily form the protective layer.

In the optical element according to the above-mentioned aspect, preferably, the protective layer is formed of a transparent inorganic material.

According to the above-mentioned structure, since the protective layer is formed of an inorganic material, the protective layer is not dissolved in an organic solvent. In this way, it is possible to improve the tolerance of the protective layer that protects the protrusions from the surrounding environment, and thus improve the durability of the optical element.

In the optical element according to the above-mentioned aspect, preferably, the protective layer includes a transparent substrate and an adhesive layer that is provided on one surface of the substrate facing the protrusions.

According to the above-mentioned structure, since the protective layer includes the substrate, the flatness of the protective layer is improved. As a result, it is possible to reliably form the cavity portions between the protrusions.

According to another aspect of the invention, there is provided a method of manufacturing an optical element having a polarizing function. The method includes: forming, on a base, a plurality of linear protrusions that are formed of a conductive material and are provided substantially in parallel to each other; and forming a protective layer that covers both upper parts of the plurality of protrusions and cavity portions that are formed between adjacent protrusions. An upper half of each of the protrusions close to the protective layer has a maximum width.

According to the above-mentioned manufacturing method since the upper half of each of the protrusions close to the protective layer has the maximum width, it is possible to increase the surface area of the upper part of the protrusion that comes into contact with the protective layer. Therefore, when the protective layer is formed on the protrusions, the surface area of the protective layer supported by the protrusions increases, and it is possible to prevent the material forming the protective layer from being inserted into a space between adjacent protrusions. In this way, it is possible to reliably form the cavity portions between the protrusions, and thus simply manufacture an optical element having high optical characteristics and durability with high yield.

In the method of manufacturing an optical element according to the above-mentioned aspect, preferably, the plurality of protrusions are formed such that the width of a lower half of each of the protrusions close to the base is gradually decreased toward the base.

According to the above-mentioned manufacturing method, since the width of the lower half of each of the protrusions close to the base is gradually decreased toward the base, the gap between adjacent protrusions is gradually increased toward the base. In this way, a space between adjacent protrusions on the base side is increased, and thus it is possible to ensure a space for the cavity portion between the protrusions.

In the method of manufacturing an optical element according to the above-mentioned aspect, preferably, the plurality of protrusions are formed such that the maximum value of the width of the protrusion is larger than half of the pitch between the plurality of protrusions.

According to the above-mentioned manufacturing method, since the maximum value of the width of the protrusion on the protective layer side is larger than half of the pitch between the plurality of protrusions, the gap between adjacent protrusions on the protective layer side is smaller than the width of the protrusion. Therefore, the surface area of an upper part of each of the protrusions that come into contact with the protective layer increases, and the gap between adjacent protrusions on the protective layer side decreases. In this way, it is possible to prevent a material forming the protective layer from being inserted into a space between adjacent protrusions.

In the method of manufacturing an optical element according to the above-mentioned aspect, preferably, the plurality of protrusions are formed such that the minimum value of the width of the protrusion is smaller than half of the pitch between the plurality of protrusions.

According to the above-mentioned manufacturing method, since the minimum value of the width of the protrusion is smaller than half of the pitch between the plurality of protrusions, the gap between adjacent protrusions on the base side is larger than the width of the protrusion. Even when the gap between adjacent protrusions on the protective layer side is small, it is possible to increase a space between adjacent protrusions on the base side.

In the method of manufacturing an optical element according to the above-mentioned aspect, preferably, the protective layer is formed of a transparent resin material.

According to the above-mentioned manufacturing method, since the transparent resin material is arranged on the protrusions, it is possible to easily form the protective layer.

In the method of manufacturing an optical element according to the above-mentioned aspect, preferably, the protective layer is formed of a transparent inorganic material.

According to the above-mentioned manufacturing method, since the protective layer is formed of an inorganic material, the protective layer is not dissolved in an organic solvent. In this way, it is possible to improve the tolerance of the protective layer that protects the protrusions from the surrounding environment, and thus improve the durability of the optical element.

In the method of manufacturing an optical element according to the above-mentioned aspect, preferably, the protective layer includes a transparent substrate and an adhesive layer that is provided on one surface of the substrate facing the protrusions.

According to the above-mentioned manufacturing method, since the protective layer includes the substrate, the flatness of the protective layer is improved. As a result, it is possible to reliably form the cavity portions between the protrusions. In addition, since the protective layer is fixed to the protrusions by the adhesive layer, it is possible to manufacture the optical element easier.

According to still another aspect of the invention, a liquid crystal display device includes: a first substrate; a second substrate; a liquid crystal layer that is interposed between the first substrate and the second substrate; and the optical elements according to the above-mentioned aspect that are provided on one surface of the first substrate facing the liquid crystal layer.

According to the above-mentioned structure, since the optical element with high optical characteristics that has both a light reflecting function and a polarizing function is provided in each liquid crystal cell, it is possible to provide a liquid crystal display device having a small thickness and high display quality.

According to the above-mentioned aspect, preferably, the liquid crystal display device further includes: a plurality of pixels; and a transmissive display region and a reflective display region that are provided in each of the plurality of pixels. Preferably, the optical element is provided in the reflective display region.

According to the above-mentioned structure, an optical element with high optical characteristics that has both a light reflecting function and a polarizing function is provided so as to correspond to the reflective display regions provided in each of the plurality of pixels. Therefore, it is possible to provide a transflective liquid crystal display device having a small thickness and high display quality.

According to yet another aspect of the invention, an electronic apparatus includes the liquid crystal display device according to the above-mentioned aspect.

According to the above-mentioned structure, it is possible to provide an electronic apparatus having a small thickness and high display quality.

### BRIEF DESCRIPTION OF THE DRAWINGS

The invention will be described with reference to the accompanying drawings, wherein like numbers reference like elements.

FIG. 1 is a perspective view schematically illustrating the structure of an optical element according to a first embodiment of the invention.

FIG. 2 is a cross-sectional view taken along the line II-II of FIG. 1.

FIGS. 3A to 3D are diagrams illustrating a method of manufacturing the optical element according to the first embodiment of the invention.

FIG. 4 is a cross-sectional view schematically illustrating a liquid crystal display device according to the first embodiment of the invention.

FIG. 5 is a plan view illustrating a pixel region of the liquid crystal display device according to the first embodiment of the invention.

FIGS. 6A to 6D are diagram illustrating the arrangement of an optical axis of the liquid crystal display device.

FIG. 7 is a cross-sectional view schematically illustrating the structure of an optical element according to a third embodiment of the invention.

FIGS. 8A and 8B are diagrams illustrating electronic apparatuses according to the invention.

### DESCRIPTION OF EXEMPLARY EMBODIMENTS

Hereinafter, exemplary embodiments of the invention will be described with reference to the accompanying drawings. A scale of each layer or member is adjusted in order to have a recognizable size in the drawings. In addition, elements, wiring lines, and connecting portions are not shown in the drawings.

### First Embodiment

### Optical Element

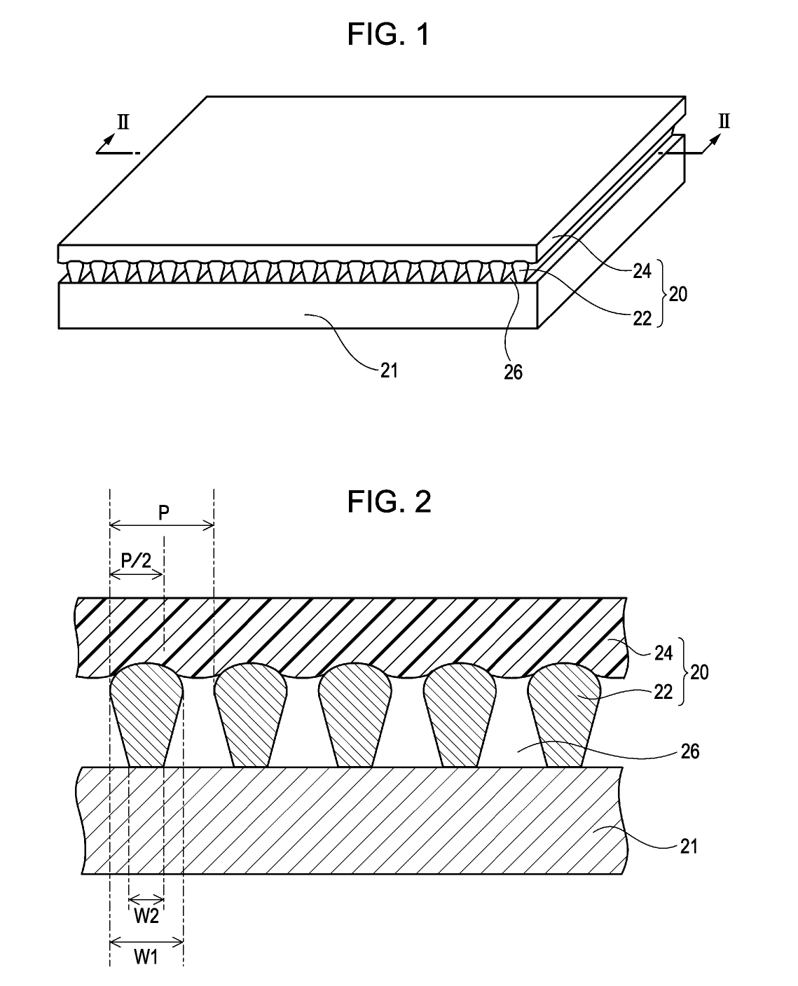

First, the structure of an optical element according to a first embodiment of the invention will be described with reference to the drawings. FIG. 1 is a perspective view schematically illustrating the optical element according to the first embodiment of the invention. FIG. 2 is a cross-sectional view taken along the line II-II of FIG. 1.

As shown in FIG. 1, an optical element 20 according to this embodiment is a wire grid polarizing element including a plurality of protrusions 22 and a protective layer 24. The optical element 20 is arranged on a base 21. The base 21 is, for example, a substrate, but it may be an outer layer covering a substrate. The plurality of protrusions 22 have linear shapes and are arranged substantially in parallel to each other on the base 21. The protrusion 22 is formed of a conductive material having high reflectance, such as aluminum. The protrusion 22 may be formed of APC (an alloy of silver, palladium, and copper).

As shown in FIG. 2, the plurality of protrusions 22 are arranged at predetermined pitches P. The pitch P is set to a value that is smaller than the wavelength of incident light, for example, 140 nm. One end of each of the protrusions 22 coming into contact with the protective layer 24 has a round surface. The protrusion 22 has a height of, for example, 100 nm. An upper half of the protrusion 22 that is close to the protective layer 24 is referred to as an upper side portion of the protrusion 22 close to the protective layer 24, and a lower half of the protrusion 22 that is close to the base 21 is referred to as a lower side portion of the protrusion close to the base 21.

The upper side portion of the protrusion 22 close to the protective layer 24 has a maximum width of the protrusion 22, and the width of the lower side portion of the protrusion close to the base 21 is gradually decreased toward the base 21. The maximum value W1 of the width of the protrusion 22 is larger than half of the pitch P, for example, in a range of 80 to 90 nm. The minimum value W2 of the width of the protrusion 22 is smaller than half the pitch P, for example, in a range of 40 to 50 nm.

The protective layer 24 is provided so as to cover the upper parts of the plurality of protrusions 22. The protective layer 24 is formed of a transparent resin material. As an example of the transparent resin material, NN525E manufactured by JSR Corporation may be used. In addition, PC403 manufactured by JSR Corporation may be used as an example of a transparent resin material having high viscosity. When the protective layer 24 is formed on the protrusions 22, it is preferable that the protective layer 24 be formed of a resin material having high viscosity in order to prevent the material forming the protective layer 24 from flowing into a space between adjacent protrusions 22, which will be described below.

When the plurality of protrusions 22 formed on the base 21 are covered with the protective layer 24, cavity portions 26 are formed between adjacent protrusions 22. The cavity portion 26 is filled with gas. For example, the gas filled in the cavity portion 26 is air. However, the gas filled in the cavity portion 26 may be an inert gas, such as argon or nitrogen. Alternatively, the cavity portion 26 may be in a vacuum.

The optical element 20 has a function of separating incident light into reflected light and transmitted light having different polarization states. The optical element 20 reflects light components that are polarized in a direction parallel to the direction in which the protrusions 22 extend, among incident light components, and transmits light components that are polarized in a direction orthogonal to the direction in which the protrusions 22 extend.

In the structure of the optical element according to the first embodiment, the protective layer 24 can protect the protrusions 22 from the surrounding environment. In addition, the cavity portion 26 formed between adjacent protrusions 22 can maintain the refractive index of a material in the vicinity of the protrusions 22 to be constant. Therefore, it is possible to provide the optical element 20 having high optical characteristics and high durability.

### Method of Manufacturing Optical Element

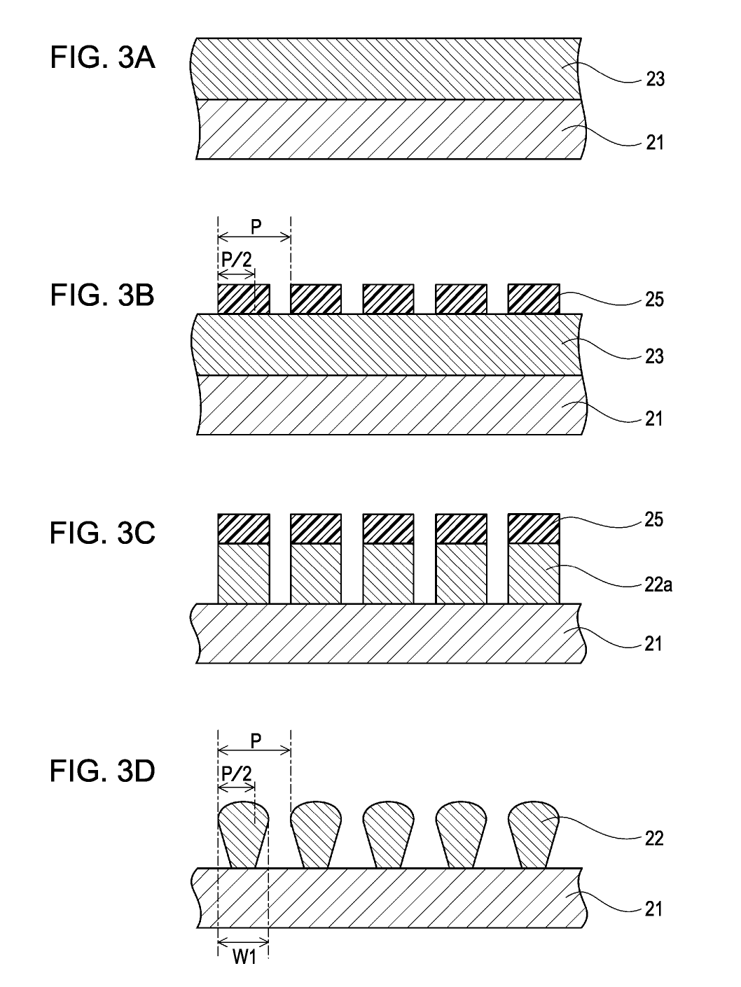

Next, a method of manufacturing the optical element according to the first embodiment of the invention will be described with reference to the drawings. FIGS. 3A to 3D are diagrams illustrating the method of manufacturing the optical element according to the first embodiment of the invention.

First, as shown in FIG. 3A, a material forming the protrusions 22 is deposited on the base 21 by, for example, a sputtering method to form a conductive material layer 23.

Then, as shown in FIG. 3B, a resist pattern 25 having a strip shape is formed on the conductive material layer 23. The resist pattern 25 is formed by providing a resist layer on the conductive material layer 23 and exposing and developing the resist layer.

In this case, since the resist pattern 25 is used as a mask to form the protrusions 22 (see FIG. 3D), the pitch of the resist pattern 25 is set to be equal to the pitch P of the protrusions 22. That is, the pitch P of the resist pattern 25 is equal to that of the protrusions 22. The width of the resist pattern 25 is set to be larger than half of the pitch P of the resist pattern 25. In addition, since the protrusions 22 are formed by over etching, the width of the resist pattern 25 is set to be larger than the maximum value W1 of the width of the protrusion 22, for example.

Then, the conductive material layer 23 is etched using the resist pattern 25 as a mask. In this way, as shown in FIG. 3C, portions of the conductive material layer 23 that are not covered with the resist pattern 25 are removed, and a plurality of linear conductive layers 22a are formed substantially in parallel to each other on the base 21. In this state, over etching is further performed such that the minimum value of the width of the conductive layer 22a is smaller than half of the pitch P of the resist pattern 25. A portion of the conductive layer 22a close to the resist pattern 25 has a maximum width, and the width of the conductive layer 22a is gradually decreased toward the base 21 by the over etching. In addition, the over etching rounds off the edge of a portion of the conductive layer 22a close to the resist pattern 25. In this method, the process shown in FIG. 3C is not necessarily performed, but etching may be continuously performed until the shape shown in FIG. 3D is finally obtained.

Then, the resist pattern 25 is removed, and as shown in FIG. 3D, a plurality of linear protrusions 22 are formed substantially in parallel to each other on the base 21. Alternatively, the protrusions 22 may be formed by a two-light-flux interference exposure method, in addition to the above-mentioned method.

Subsequently, as shown in FIG. 2, a material forming the protective layer 24 is deposited so as to cover the upper parts of the plurality of protrusions 22 by, for example, a sputtering method, thereby forming the protective layer 24. The cavity portions 26 are formed between adjacent protrusions 22 by the protective layer 24 formed on the protrusions. The cavity portions 26 are filled with the atmosphere of the process of forming the protective layer 24. For example, when this process is performed in the atmosphere of an inert gas, the cavity portions 26 are filled with the inert gas.

In this structure, since an upper side portion of the protrusion 22 close to the protective layer 24 has a maximum width, it is possible to increase the surface area of an upper part of the protrusion 22 that comes into contact with the protective layer 24. Therefore, when the material forming the protective layer 24 is deposited on the protrusions 22, the material forming the protective layer 24 is supported by the protrusions 22 having a large surface area. Since the maximum value W1 of the width of the protrusion 22 is larger than half of the pitch P, the gap between the upper side portions of the adjacent protrusions 22 close to the protective layer 24 is smaller than the width of the protrusion 22. According to this structure, it is possible to increase the surface area of the upper part of each of the protrusions 22 that come into contact with the protective layer 24 and decrease the gap between the adjacent protrusions 22 on the side of the protective layer 24. As a result, it is possible to prevent the material forming the protective layer 24 from being inserted into the space between adjacent protrusions 22, and thus reliably form the cavity portions 26 with ease. When a resin material having high viscosity is applied onto the protrusions 22 to form the protective layer 24, it is possible to further improve the effect of preventing the resin material forming the protective layer 24 from being inserted into the space between adjacent protrusions 22.

Meanwhile, since the width of the protrusion 22 is gradually decreased toward the base 21, the gap between adjacent protrusions 22 is gradually increased toward the base 21. In addition, since the minimum value W2 of the width of a lower side portion of the protrusion 22 close to the base 21 is smaller than half of the pitch P, the gap between adjacent protrusions 22 in the vicinity of the base 21 is larger than the width of the protrusion 22. In this way, even when the gap between the lower side portions of the adjacent protrusions 22 close to the protective layer 24 is small, it is possible to increase the space between the lower side portions of the adjacent protrusions 22 close to the base 21. As a result, it is possible to reliably form the cavity portions 26 with ease.

The optical element 20 can be manufactured by the above-mentioned processes. According to the method of manufacturing the optical element according to the first embodiment of the invention, it is possible to simply and easily manufacture the optical element 20 having high optical characteristics and durability with high yield.

### Liquid Crystal Display Device

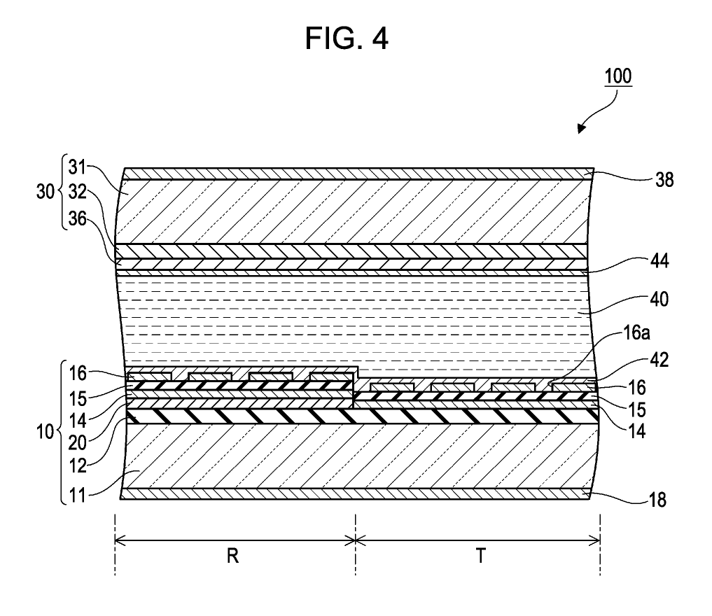

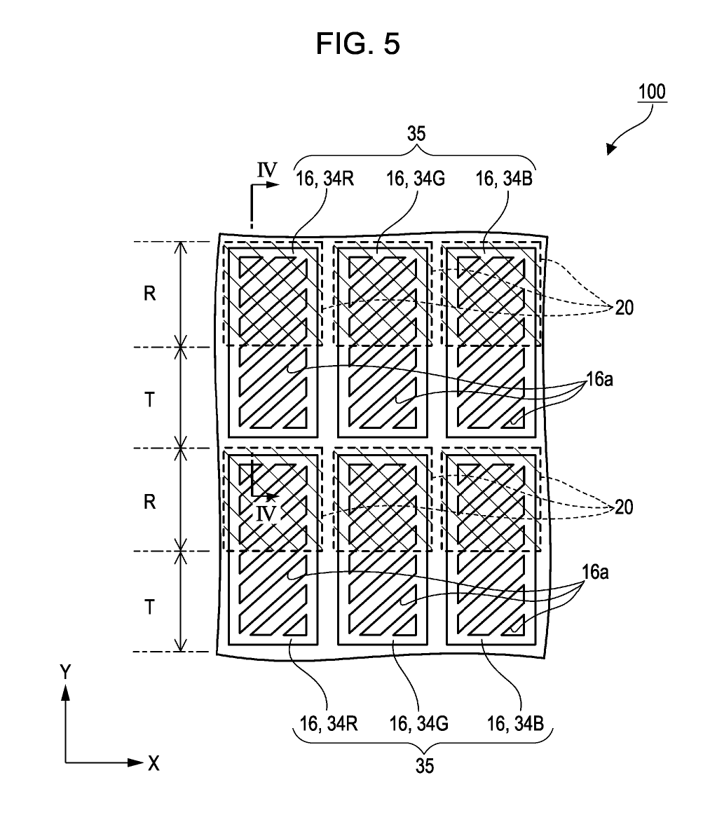

Next, the structure of a liquid crystal display device according to the first embodiment will be described with reference to the drawings. FIG. 4 is a cross-sectional view schematically illustrating the structure of the liquid crystal display device according to the first embodiment. Specifically, FIG. 4 is a cross-sectional view taken along the line IV-IV of FIG. 5. FIG. 5 is a plan view illustrating a pixel region of the liquid crystal display device according to the first embodiment, and shows the positional relationship between pixel electrodes and optical elements.

As shown in FIG. 4, a liquid crystal display device 100 according to this embodiment is a transflective FFS (fringe-field switching) liquid crystal display device having transmissive display regions T and reflective display regions R. The liquid crystal display device 100 includes an element substrate 10 having a first substrate 11 and the optical elements 20, an opposite substrate 30 having a second substrate 31, and a liquid crystal layer 40.

The element substrate 10 includes the first substrate 11, a first insulating layer 12, the optical elements 20, a common electrode 14, a second insulating layer 15, and pixel electrodes 16. The first substrate 11 is formed of a transparent material such as glass. The first insulating layer 12 is formed so as to cover one surface of the first substrate 11 facing the liquid crystal layer 40. The first insulating layer 12 serves as the base of the optical elements 20 in the liquid crystal display device 100. Although not shown in the drawings, concave and convex portions that scatter external light are formed in the reflective display regions R of the first insulating layer 12. The optical element 20 is formed in the reflective display region R on the first insulating layer 12.

The common electrode 14 is formed so as to be laid across the reflective display region R and the transmissive display region T. In the reflective display region R, the common electrode 14 is formed on the optical element 20, and in the transmissive display region T, the common electrode 14 is formed on the first insulating layer 12. The common electrode 14 is formed of, for example, ITO (indium tin oxide). The second insulating layer 15 is formed on the common electrode 14 so as to cover the upper surface thereof. The pixel electrodes 16, each having a plurality of slit-shaped opening 16a, are formed on the second insulating layer 15. The pixel electrode 16 is formed of, for example, ITO.

As shown in FIG. 5, each of the plurality of pixel electrodes 16 is arranged so as to be laid across the reflective display region R and the transmissive display region T. The plurality of pixel electrode 16 are arranged in a matrix. The plurality of pixel electrode 16 are adjacent to one another in the X-axis direction such that the reflective display regions R or the transmissive display regions T thereof are opposite to each other, and they are adjacent to one another in the Y-axis direction such that the reflective display regions R and the transmissive display regions T thereof are opposite to each other.

The plurality of pixel electrodes 16 correspond to red, green, and blue color filters of a color filter layer 32, which will be described below (see FIG. 4). Three color sub-pixels 34R (red), 34G (green), and 34B (blue) are formed by combinations of three pixel electrodes 16 and the red, green, and blue color filters. The three sub-pixels 34R, 34G, and 34B form one pixel 35. Therefore, the one pixel 35 includes the reflective display region R and the transmissive display region T.

Returning to FIG. 4, a first polarizing plate 18 is provided on one surface of the element substrate 10 opposite to the liquid crystal layer 40. Although not shown in the drawings, wiring patterns, connecting portions, and devices for driving the liquid crystal layer 40 are provided on the element substrate 10.

The opposite substrate 30 is positioned on an observer side of the liquid crystal display device 100. The opposite substrate 30 includes a second substrate 31, the color filter layer 32, and a color filter protecting layer 36. The second substrate 31 is formed of a transparent material such as glass. The color filter layer 32 and the color filter protecting layer 36 are sequentially laminated on one surface of the second substrate 31 facing the liquid crystal layer 40. The color filter layer 32 includes, for example, red, green, and blue color components. A second polarizing plate 38 is provided on one surface of the opposite substrate 30 opposite to the liquid crystal layer 40, that is, on the observer side.

The liquid crystal layer 40 is interposed between the element substrate 10 and the opposite substrate 30. A first alignment film 42 is formed on one surface of the element substrate 10 facing the liquid crystal layer 40 so as to cover the second insulating layer 15 and the pixel electrodes 16. In addition, a second alignment film 44 is formed on the one surface of the opposite substrate 30 facing the liquid crystal layer 40 so as to cover the color filter protecting layer 36. The alignment direction of the liquid crystal layer 40 is restricted by the first alignment film 42 and the second alignment film 44 subjected to an alignment process, and the liquid crystal layer 40 is homogeneously aligned. In addition, a phase difference corresponding to half of the wavelength of incident visible light occurs between the incident visible light and light passing through the liquid crystal layer 40.

### Display Principle of Liquid Crystal Display Device

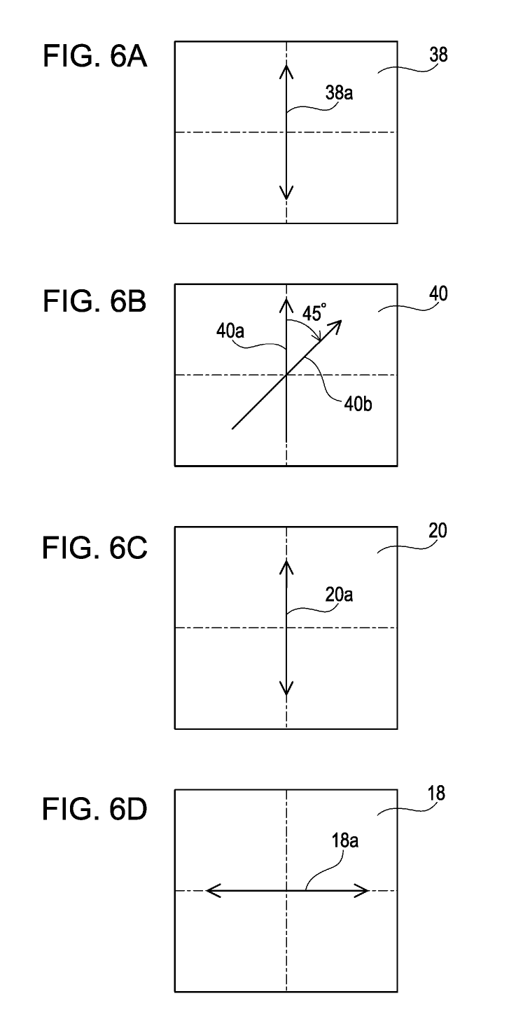

Next, the arrangement of an optical axis of the liquid crystal display device 100 will be described. FIGS. 6A to 6D are diagrams illustrating the arrangement of the optical axis of the liquid crystal display device 100. FIG. 6A shows a transmission axis 38a of the second polarizing plate 38. FIG. 6B shows the alignment direction of the liquid crystal layer 40. An alignment direction 40a of the liquid crystal layer 40 is parallel to the transmission axis 38a. In this state, when a voltage is applied, an alignment direction 40b of the liquid crystal layer 40 is inclined 45 degrees with respect to the transmission axis 38a, for example.

In this embodiment, the direction in which the protrusions 22 of the optical element 20 extend is orthogonal to the transmission axis 38a. Therefore, the optical element 20 transmits light components that are polarized in a direction parallel to the transmission axis 38a, and reflects light components that are polarized in a direction orthogonal to the transmission axis 38a. In FIG. 6C, the direction in which polarized light components pass through the optical element 20 is shown as a transmission axis 20a. FIG. 6D shows a transmission axis 18a of the first polarizing plate 18. The transmission axis 18a is orthogonal to the transmission axis 38a.

Next, the display principle of the liquid crystal display device 100 will be described. In this embodiment, the liquid crystal display device 100 is a normally black type in which dark display is performed when no voltage is applied to the liquid crystal layer 40. Therefore, when the dark display is performed, no voltage is applied to the liquid crystal layer 40.

In the reflective display region R, light incident on the second polarizing plate 38 is linearly polarized to be parallel to the transmission axis 38a, and then incident on the liquid crystal layer 40. Since the linearly polarized light incident on the liquid crystal layer 40 has a polarizing axis that is parallel to the alignment direction 40a of the liquid crystal layer 40, the linearly polarized light passes through the liquid crystal layer 40 without a phase difference, and is then incident on the optical element 20. The linearly polarized light having an optical axis parallel to the transmission axis 38a passes through the optical element 20 and is then absorbed by the first polarizing plate 18. Therefore, no light is returned to the second polarizing plate 38 (observer side), which results in dark display.

Meanwhile, in the transmissive display region T, light incident on the first polarizing plate 18 is linearly polarized to be parallel to the transmission axis 18a, and then incident on the liquid crystal layer 40. Since the linearly polarized light incident on the liquid crystal layer 40 has a polarizing axis that is orthogonal to the alignment direction 40a of the liquid crystal layer 40, the linearly polarized light passes through the liquid crystal layer 40 without a phase difference, and is then incident on the second polarizing plate 38. The linearly polarized light having an optical axis parallel to the transmission axis 18a is absorbed by the second polarizing plate 38. Therefore, no light reaches the second polarizing plate 38 (observer side), which results in dark display.

Next, when bright display is performed, a voltage is applied to the liquid crystal layer 40. When the voltage is applied, the alignment direction 40b of the liquid crystal layer 40 is inclined, for example, 45 degrees with respect to the transmission axis 38a of the second polarizing plate 38.

In the reflective display region R, light incident on the second polarizing plate 38 is linearly polarized to be parallel to the transmission axis 38a and then incident on the liquid crystal layer 40. When the linearly polarized light incident on the liquid crystal layer 40 passes through the liquid crystal layer 40, the linearly polarized light is given a phase difference corresponding to half of the wavelength of the light, and the optical axis of the linearly polarized light is orthogonal to the transmission axis 38a. Then, the linearly polarized light is incident on the optical element 20. Since the optical axis of the linearly polarized light is also orthogonal to the transmission axis 20a, the linearly polarized light is reflected from the optical element 20 to be incident on the liquid crystal layer 40 again. Then, the linearly polarized light passes through the liquid crystal layer 40 again, and the liquid crystal layer 40 gives the linearly polarized light a phase difference corresponding to half of the wavelength thereof. Then, the optical axis of the linearly polarized light is parallel to the transmission axis 38a, and the linearly polarized light passes through the second polarizing plate 38 to be emitted from the second polarizing plate 38 (observer side), which results in bright display.

Meanwhile, in the transmissive display region T, light incident on the first polarizing plate 18 is linearly polarized to be parallel to the transmission axis 18a, and then incident on the liquid crystal layer 40. When the linearly polarized light incident on the liquid crystal layer 40 passes through the liquid crystal layer 40, it is given a phase difference corresponding to half of the wavelength thereof, and the optical axis of the linearly polarized light is orthogonal to the transmission axis 18a. Then, the linearly polarized light is incident on the second polarizing plate 38. Since the optical axis of the linearly polarized light is parallel to the transmission axis 38a, the linearly polarized light passes through the second polarizing plate 38 and is then emitted from the second polarizing plate 38 (observer side), which results in bright display.

In the structure according to the first embodiment, the optical element 20 with high optical characteristics that has both a light reflecting function and a light polarizing function is provided in the reflective display region R in each liquid crystal cell. Therefore, it is possible to provide the transflective liquid crystal display device 100 having a small thickness and high display quality.

### Second Embodiment

Next, the structure of an optical element according to a second embodiment of the invention will be described. The structure of the optical element according to the second embodiment is similar to that of the optical element according to the first embodiment, and thus an illustration thereof will be omitted.

The optical element according to the second embodiment differs from the optical element according to the first embodiment in a material forming a protective layer. In the optical element according to the second embodiment, the protective layer is formed of an inorganic material such as SiO₂.

The second embodiment has the following effects. When the protective layer is formed of an inorganic material, the protective layer is not dissolved in an organic solvent. Therefore, for example, when a layer made of an organic material is formed on the optical element, it is possible to prevent the protective layer from being damaged. In this way, the tolerance of the protective layer that protects the protrusions from the surrounding environment is improved, and it is possible to improve the durability of the optical element.

### Third Embodiment

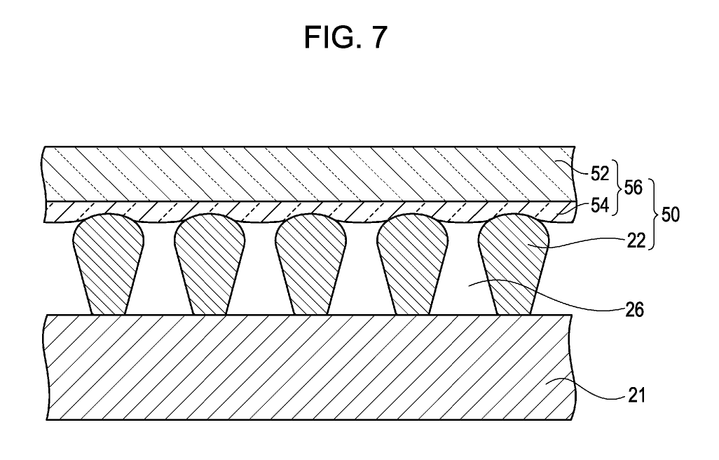

Next, the structure of an optical element according to a third embodiment of the invention will be described with reference to the drawings. In the third embodiment, the same components as those in the first embodiment are denoted by the same reference numerals, and a description thereof will be omitted. FIG. 7 is a cross-sectional view schematically illustrating the structure of the optical element according to the third embodiment.

An optical element 50 according to the third embodiment differs from the optical element 20 according to the first embodiment in that a protective layer includes a substrate and an adhesive layer. In addition, in the structure of a liquid crystal display device according to this embodiment, since only the optical element 50 is substituted for the optical element 20, an illumination of the liquid crystal display device will be omitted.

As shown in FIG. 7, the optical element 50 includes a plurality of protrusions 22 and a protective layer 56. The protective layer 56 includes a substrate 52 and an adhesive layer 54. The substrate 52 is formed of a transparent material, for example, glass. The substrate 52 may be formed of plastic. The adhesive layer 54 is provided on one surface of the substrate 52 facing the protrusions 22. The adhesive layer 54 may be provided on the entire surface of the substrate 52 facing the protrusions 22, or it may be provided on only a portion of the substrate 52 that comes into contract with the protrusions 22. The adhesive layer 54 may be formed of any material as long as the material is transparent and has sufficient adhesion to fix the protrusions 22 to the substrate 52. The protective layer 56 may be an adhesive film including the film substrate 52 and the adhesive layer 54.

A method of manufacturing the optical element 50 according to the third embodiment differs from the method of manufacturing the optical element 20 according to the first embodiment in a process of providing the protective layer on the protrusions. In this embodiment, the protective layer 56 is arranged such that the adhesive layer 54 comes into contact with the upper parts of the protrusions 22, and pressure is applied to the substrate 52 to fix the adhesive layer 54 to the upper parts of the protrusions 22.

In the structure according to the third embodiment, since the protective layer 56 includes the substrate 52, the flatness of the protective layer 56 is improved. Therefore, it is possible to reliably form the cavity portions 26 between the protrusions 22. In addition, since the protective layer 56 is fixed to the protrusions 22 by the adhesive layer 54, it is possible to manufacture the optical element 50 easier.

In the liquid crystal display device 100, since the flatness of the protective layer 56 is improved, the flatness of the common electrode 14 and the pixel electrodes 16 formed on the optical elements 50 is also improved. Therefore, when a voltage is applied between the common electrode 14 and the pixel electrodes 16, a uniform electric field is generated between the common electrode 14 and the pixel electrodes 16 in a direction parallel to the surface of the element substrate 10. In addition, since the flatness of the common electrode 14 and the pixel electrodes 16 is improved, it is possible to make the thickness of the liquid crystal layer 40 facing the common electrode and the pixel electrodes uniform. As a result, it is possible to provide the liquid crystal display device 100 having high display quality.

### Electronic Apparatuses

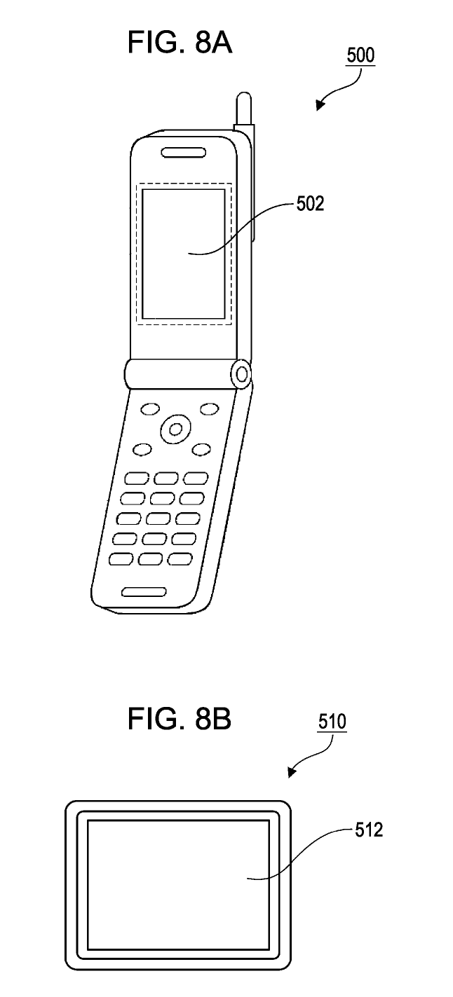

As shown in FIG. 8A, for example, the liquid crystal display device 100 can be mounted in a mobile phone 500, which is an electronic apparatus. As shown in FIG. 8B, the electronic apparatus may be an electronic viewfinder 510. The mobile phone 500 and the electronic viewfinder 510 include the liquid crystal display devices 100 in their display units 502 and 512, respectively. According to this structure, the mobile phone 500 and the electronic viewfinder 510 respectively provided with the display units 502 and 512 can have high display quality.

The electronic apparatus may be a mobile computer, a digital camera, a digital video camera, an audio apparatus, and a liquid crystal projector.

Although the exemplary embodiments of the invention have been described above, the invention is not limited thereto. Various modifications and changes of the invention can be made without departing from the scope and spirit of the invention. For example, the following modifications can be considered.

### First Modification

In the optical elements 20 and 50 according to the above-described embodiments, each of the protrusions 22 that come into contact with the protective layer 24 or 56 has a round surface, but the invention is not limited thereto. For example, the surface of each of the protrusions 22 that come into contact with the protective layer 24 or 56 may be substantially flat.

### Second Modification

The liquid crystal display devices according to the above-described embodiments are transflective FFS liquid crystal display devices, but the invention is not limited thereto. For example, the liquid crystal display device may be an IPS (in-plane switching) liquid crystal display device, an ECB (electrically controlled birefringence) liquid crystal display device, or a VA (vertical alignment) liquid crystal display device. In addition, the liquid crystal display devices may be reflective liquid crystal display devices.

Further, components that are not described in the above embodiments may be formed of known materials, and the components may be manufactured by known methods.

What is claimed is:

1. An optical element having a polarizing function, comprising:
a plurality of linear protrusions that are formed of a conductive material and are provided substantially in parallel to each other on a base; and
a protective layer that covers both upper parts of the plurality of protrusions and cavity portions formed between adjacent protrusions,
wherein an upper half of each of the protrusions close to the protective layer has a maximum width.

2. The optical element according to claim 1,
wherein the width of a lower half of each of the protrusions close to the base is gradually decreased toward the base.

3. The optical element according to claim 1,
wherein the maximum value of the width of the protrusion is larger than half of the pitch between the plurality of protrusions.

4. The optical element according to claim 3,
wherein the minimum value of the width of the protrusion is smaller than half of the pitch between the plurality of protrusions.

5. The optical element according to claim 1,
wherein the protective layer is formed of a transparent resin material.

6. The optical element according to claim 1,
wherein the protective layer is formed of a transparent inorganic material.

7. The optical element according to claim 1,
wherein the protective layer includes:
a transparent substrate; and
an adhesive layer that is provided on one surface of the substrate facing the protrusions.

8. A method of manufacturing an optical element having a polarizing function, the method comprising:
forming, on a base, a plurality of linear protrusions that are formed of a conductive material and are provided substantially in parallel to each other; and
forming a protective layer that covers both upper parts of the plurality of protrusions and cavity portions that are formed between adjacent protrusions,
wherein an upper half of each of the protrusions close to the protective layer has a maximum width.

9. The method of manufacturing an optical element according to claim 8,
wherein the plurality of protrusions are formed such that the width of a lower half of each of the protrusions close to the base is gradually decreased toward the base.

10. The method of manufacturing an optical element according to claim 8,
wherein the plurality of protrusions are formed such that the maximum value of the width of the protrusion is larger than half of the pitch between the plurality of protrusions.

11. The method of manufacturing an optical element according to claim 10,
wherein the plurality of protrusions are formed such that the minimum value of the width of the protrusion is smaller than half of the pitch between the plurality of protrusions.

12. The method of manufacturing an optical element according to claim 8,
wherein the protective layer is formed of a transparent resin material.

13. The method of manufacturing an optical element according to claim 8,
wherein the protective layer is formed of a transparent inorganic material.

14. The method of manufacturing an optical element according to claim 8,
wherein the protective layer includes:
a transparent substrate; and
an adhesive layer that is provided on one surface of the substrate facing the protrusions.

15. A liquid crystal display device comprising:
a first substrate;
a second substrate;
a liquid crystal layer that is interposed between the first substrate and the second substrate; and
the optical elements according to claim 1 that are provided on one surface of the first substrate facing the liquid crystal layer.

16. The liquid crystal display device according to claim 15, further comprising:
a plurality of pixels; and
a transmissive display region and a reflective display region that are provided in each of the plurality of pixels,
wherein the optical element is provided in the reflective display region.

17. An electronic apparatus comprising the liquid crystal display device according to claim 15.
